(19) United States
(12) Patent Application Publication
(10) Pub. No.: US 2015/0252165 A1
(43) Pub. Date: Sep. 10, 2015

(54) EXPANDABLE COMPOSITION IN THE FORM OF A GRANULAR MATERIAL

(71) Applicant: SIKA TECHNOLOGY AG, Baar (CH)

(72) Inventors: Karsten Frick, Remetschwil (CH); Nicolae Bordeanu, Winterthur (CH); Frank Hoefflin, Baden (CH)

(73) Assignee: SIKA TECHNOLOGY AG, Baar (CH)

(21) Appl. No.: 14/434,925

(22) PCT Filed: Nov. 6, 2013
(86) PCT No.: PCT/EP2013/073153

§ 371 Date: Apr. 10, 2015

(30) Foreign Application Priority Data
Nov. 6, 2012 (EP) 12191482.4

(51) Int. Cl. C08J 9/16; B29C 44/12; C08J 9/00; C08J 9/12; C08J 9/06

(52) U.S. Cl. CPC C08J 9/16; C08J 9/12; C08J 9/06; C08J 9/0085; C08J 9/0066; B29C 44/128; C08J 2363/10; C08J 2363/00; B29K 2063/00

(57) ABSTRACT

The present invention relates to expandable compositions in the form of granular materials that are based on epoxy resins with a content of binders and curing agents for curing the epoxy resin. Corresponding compositions can be readily introduced into hollow bodies, for example, into sticks or roof supports and expanded to a foam by heating the composition and cured. This results in hollow bodies filled with foam that are distinguished by significantly improved mechanical properties compared to comparable hollow bodies without a foam filling. At the same time, the granular materials according to the invention can be very readily processed without a complex and expensive two-component injection-molding process being necessary.

### TECHNICAL AREA

The invention relates to an expandable composition in the form of a granulated material and to hollow bodies filled with an expanded composition obtainable from this composition. Furthermore, the invention relates to the use of the expandable composition for stiffening hollow spaces and to a method for stiffening hollow spaces in which the composition is filled into a hollow space and is expanded and cured in it.

### PRIOR ART

Structural members with hollow spaces are often used in constructions of all types, in particular in structures for transport means. This construction allows the weight of the construction and the cost of the material to be kept low. However, this can lead to a reduction of the stability of the structural member when the structural member is exposed to strong deforming loads.

Structural members are therefore as a rule reinforced at positions at which a special loading of the structural member is expected. Such loads or load instances to be expected are often known as standardized load instances and allow the person skilled in the art to investigate the behavior, in particular the deforming behavior of structural members in the case of an external action of force on the structural member. Such standardized instances of loads are very significant in the vehicle manufacturing industry. They allow the behavior of reinforced structures, for example in the case of vehicle accidents to be analysed using standardized load instances. The vehicle manufacturing industry knows a plurality of such standardized load instances, in particular the block collision, the collision against an obstacle, the protective plank collision, the vehiclevehicle collision, the side collision or the rear collision. Standardized load instances include, among other things, crash test programs such as the European New Car Assessment Program (Euro NCAP) or the US New Car Assessment Program (US NCAP). The action of force from the outside can therefore correspond to a standardized load instance, in particular to standardized load instances from the vehicle manufacturing industry such as those previously cited.

If a structural component deforms due to an external action of force, the structural component usually loses stability.

The ability to resist compressive forces, in particular the ability to resist deformation in the case of an external action of force, is particularly important if the shape of the structural component, in particular the cross section, is designed in such a manner that the structural component makes a contribution to the stability of the transport means. If the structural component is, for example, a B pillar of the vehicle, then the structural component loses stability in the case of a deformation, in particular if the deformation affects the cross section, for example, in the case of a bend due to an external action of force. This has the consequence that the stability of the vehicle is adversely affected.

In automobile construction stiffening of hollow spaces and vehicles is currently brought about by the using of injection-molded parts consisting of a granular material and of a granular support material (as a rule polyamide). Reinforcement elements designed in this manner are generally manufactured by a 2K injection-molding process in that first the granular support material is injected and cooled below the solidification point. Subsequently, an expandable composition is also applied on the support by an injection-molding process and therefore supplies form-stable and consistent parts. However, the disadvantage of such a production is that a two-component injection-molding process is associated with high costs in the production of three-dimensional parts for automobile construction and the producers of corresponding parts must in addition operate with a high cost.

US 2009/76903 A1 describes an expandable composition for injection-molding methods based on epoxy resins, copolymers, fillers such as, among other things, glass fibers, blowing agents and curing agents. For compositions with copolyesters, improved mechanical properties are achieved compared to compositions without this component.

US 2009/258217 A1 describes structural reinforcement materials for sealing hollow spaces in vehicles. The materials are based on epoxy resins, fillers such as aramid fibers and glass fibers as well as curing agents and blowing agents. These compositions are also brought into the desired form with the aid of an injection-molding process.

US 2004/266899 A1 also describes expandable compositions for use in injection-molding processes. The compositions described in it contain in addition to epoxy resins, blowing agents and various fillers, among other things, nitrile rubber for improving the mechanical properties.

US 2007/034432 A1 describes compositions for reinforcing structural components in the automobile sector. The compositions described in this document are based on epoxy resins, blowing agents, fillers and impact-strength modifiers and are introduced by an injection-molding process into the appropriate structural components.

Finally, EP 2 468 794 A1 describes two-component, heat-curing mixtures of granular material in which the first component contains an epoxy resin while the second component is epoxide-free but contains a curing agent that can be activated by heat with dicyandiamide and a thermoplastic that is solid at room temperature. Furthermore, the first and/or the second component contains a heat-curable blowing agent that is used for the expansion of the composition. A long shelf life of the composition is achieved in this document by the special distribution of the individual components of the composition.

In many other usages, for example, in bicycle frames, sticks, roof supports or furniture, no filling of the hollow space was previously performed. Instead, the design, for example of tubes, was selected in such a manner that the desired elevation of the maximum bending force is achieved. However, this has the disadvantage that, depending on the loading of the material to be expected, a greater thickness of the tubes used must be selected, which can greatly increase the weight of the resulting product. Therefore, metals such as aluminum or steel used, for example, in bicycle frames or sticks, have densities of 2.7 g/cm³ or 7.85 g/cm³, which can result in a high end weight of the products produced.

### PRESENTATION OF THE INVENTION

There is therefore a need for compositions as well as simple methods for the strengthening and stiffening of hollow spaces, for example, in automobile construction or for the higher strength of tubes that ensure an improved stability of the produced composite with reduced weight at the same time. The requirement for material and with it the costs of the products produced can preferably be reduced by this composition. In comparison to the two-component injection molding process, there is a need for a composition that can be substituted in a corresponding process and that is associated with less complex apparatus and lower cost than the currently used two-component injection molding process and nevertheless delivers comparable results.

These problems are solved in accordance with the invention by an expandable composition in the form of a granular material comprising 30-75 wt % epoxy resin, up to 5 wt % blowing agent, up to 5 wt % curing agent, 5-30 wt % fibers, 10-40 wt % fillers, up to 10% thixotropic agent and 0-1 wt % catalyst, wherein the data in wt % refers to the total weight of the expandable composition. As a result of their content of blowing agent, a foam is produced during the expansion of the expandable composition, so that the concepts “expanding” and “foaming” can be interchangeably used in the present invention.

The present invention also relates to the use of a composition as previously described for stiffening hollow spaces that is characterized in that the composition is expanded and cured inside the hollow space.

Furthermore, the present invention relates to a method for stiffening hollow spaces, comprising i) the filling of a hollow space with the granular material of a composition as previously described, and ii) the heating of the filled hollow space to a temperature above the softening point of the composition and above the activation temperature of the blowing agent and of the catalyst, and for a time period until the composition has substantially cured.

The advantages of the invention can be seen, among other things, in that the use in accordance with the invention of the composition such as previously described can significantly reduce the time and expense for the production of products such as three-dimensional parts for automobile construction or tubes that are filled with an expanded composition in accordance with the present invention.

Furthermore, it was surprisingly determined that the mechanical properties, in particular the stiffness and elongation at rupture of hollow spaces formed with such a composition show a significant improvement in comparison to hollow spaces not foamed with a corresponding composition. It is therefore possible to reduce the design and the thickness of the hollow bodies while retaining the same mechanical properties, as a result of which the weight of for example, hollow bodies based on metals or composite materials such as glass fiber composites (GFC) or carbon fiber composites (CFC) is also reduced. It was also surprisingly determined that hollow bodies foamed with the previously cited expandable composition display similar mechanical properties to those of analogous bodies produced with a two-component injection-molding process.

Other advantageous embodiments of the invention result from the subclaims.

### WAYS OF CARRYING OUT THE INVENTION

The expandable composition in the form of a granular material that forms a foam during the expansion and is required for the production of hollow bodies filled in accordance with the invention preferably contains an epoxy resin as base component. In particular, expandable compositions comprising 30-75 wt % epoxy resin, up to 5 wt % blowing agent, up to 5 wt % curing agent, 5-30 wt % fibers, 10-40 wt % fillers, up to 10 wt % thixotropic agent, 0-10 wt % wax and 0-1 wt % catalyst proved to be advantageous in the scope of the present invention.

The present invention has no relevant limitations regarding the dimensions of the granular material. However, a person skilled in the art will appropriately adjust the dimensions of the particles of granular material as a function of the intended use. The particles of granular material in accordance with the invention preferably have an average largest diameter (determined at the thickest position of the particle) in the range of approximately 1 to 8 mm, in particular approximately 2 to 5 mm. In addition or alternatively to the above, the particles of granular material in accordance with the invention have an average smallest diameter (determined at the thinnest position of the particle) in the range of approximately 0.1 to 5 mm, in particular approximately 1 to 2 mm.

As previously described, the expandable composition is preferably based on an epoxy resin. It is preferred if the expandable composition is based on a one-component epoxy resin composition, wherein the epoxy resin has on average more than one epoxy group per molecule. A solid epoxy resin is preferably used as epoxy resin. However, it is also possible to include a liquid epoxy resin or a mixture of one or more solid and/or liquid epoxy resins in the composition of the invention. The concept “solid epoxy resin” is well-known to the person skilled in the art and is used in contrast to “liquid epoxy resin.” The glass temperature of solid epoxy resins is above room temperature (23° C.), i.e., they can be comminuted at room temperature to free-flowing powders.

Such epoxy resins are commercially available, for example, from The Dow Chemical Company, USA under the trade name Araldite® GT 7071 from Huntsman International LLC, USA or from Hexigon Specialty Chemicals Inc., USA.

Liquid epoxy resins that can be used in the framework of the composition of the invention are commercially obtainable, for example, under the trade names Araldite® GY 250, Araldite® PY 304, Araldite® GY 282 from Huntsman International LLC, USA or D.E.R® 331 or D.E.R® 330 from The Dow Chemical Company, USA or under the trade name Epikote® 828 or Epikote® 862 from Hexigon Specialty Chemicals Inc., USA.

The expandable composition especially preferably comprises a rubber-modified epoxy resin. The rubber is preferably a nitrile rubber, especially preferably a rubber based on butadiene and acrylonitrile. A quite especially preferred rubber-modified epoxy resin is the reaction product of a carboxy-terminated liquid nitrile rubber (CTBN) with a solid epoxy resin. The solid epoxy resin is preferably a solid resin based on bisphenol A. In addition, the rubber-modified solid resin can contain a polyphenol comprising epoxide groups, for example in the form of a novolak resin such as, e.g. DEN 431 or DEN 438 (obtainable from Dow Chemical).

It is especially preferable if the epoxy resin of the composition of the invention comprises a mixture consisting of a solid epoxy resin and rubber-modified epoxy resin, preferably in a ratio of approximately 10:1 to 5:2, in particular approximately 6:1 to 4:1.

Furthermore, it is preferred if the solid epoxy resin is present in the expandable composition with a content in the range of approximately 40 to 60 wt %, in particular approximately 45 to 55 wt % relative to the total weight of the expandable composition. The rubber-modified epoxy resin is preferably present in the expandable composition with a content in the range of approximately 5 to 20 wt %, in particular approximately 5 to 10 wt % relative to the total weight of the expandable composition.

The blowing agent advantageously comprises a chemical or a physical blowing agent. Chemical blowing agents are organic or inorganic compositions that decompose under the influence of temperature, moisture or electromagnetic radiation, wherein at least one of the decomposition products is a gas. For example, compositions that change into the gaseous aggregation state upon elevation of the temperature can be used as physical blowing agents. Consequently, chemical as well as physical blowing agents are capable of producing foam structures in polymers.

The expandable composition is preferably foamed under the influence of elevated temperature, wherein a mixture of at least one chemical blowing agent and at least one physical blowing agent are especially preferably used. Suitable chemical blowing agents are, for example, azodicarbonamides, sulfohydrazides, hydrogen carbonates or carbonates. Suitable blowing agent are commercially available, for example, under the trade names Expancel® from the Akzo Nobel company, The Netherlands, or under the trade name Celogen® from the company Chemtura Corp., USA. Suitable physical blowing agents are available, for example, under the trade names Expancel® from the Akzo Nobel company, The Netherlands, or under the trade name Celogen® from the company Chemtura Corp., USA.

The heat required for the expansion can be introduced by external or internal heat sources such as an exothermic chemical reaction. The expandable composition is preferably expandable at a temperature of approximately 110° C. to 250° C., in particular approximately 140° C. to 200° C. and preferably from approximately 160° C. to 180° C. It is apparent to a person skilled in the art from these temperatures that curing takes place in compositions based on epoxy that additionally contain a catalyst suitable for the epoxy polymerization.

The blowing agent is preferably present in the composition in an amount of up to 5 wt %, in particular 0.01 wt % or more. The blowing agent is especially preferably present in an amount of approximately 0.3 to 5 wt %, in particular 0.5 to 3 wt % and quite especially preferably 1 to 2.5 wt %. If a mixture of physical and chemical blowing agents is used as blowing agent, then the chemical blowing agent is preferably approximately 0.1 to 0.5 wt %, especially preferably approximately 0.2 to 0.4 wt % relative to the total weight of the expandable composition. The physical blowing agent is preferably present in this case with a content of approximately 0.5 to 5 wt %, especially preferably approximately 0.7 to 4 wt % and in particular approximately 1 to 2.5 wt % relative to the total weight of the expandable composition. If only a chemical blowing agent is used as blowing agent, then its content in the expandable composition is preferably approximately 0.5 to 2.5 wt % and in particular approximately 0.75 to 2 wt %. If only a physical blowing agent is used as blowing agent, then its content in the expandable composition is preferably approximately 2.0 to 6 wt % and in particular approximately 2.5 to 5 wt %.

Surprisingly it was found that the use of physical blowing agents in comparison to chemical blowing agents results in improved compressive strengths of the foamed material. It is therefore preferred if the composition of the invention contains a physical blowing agent, especially preferably if the physical blowing agent is present in a weight excess in comparison to the chemical blowing agent, and most preferably if the blowing agent consists of physical blowing agent.

It is preferred in the framework of the present invention if the blowing agent is added in an amount that produces a certain maximal expansion (under normal pressure conditions). Care should be taken that the maximal expansion is influenced not only by the amount of the blowing agent but also by the type or expansion performance of the blowing agent used (i.e., the volumetric increase per unit weight of the blowing agent). Compositions are preferred in which the blowing agent is contained in an amount such that during the expansion a degree of expansion of approximately 150 to 500%, preferably approximately 185 to 450% and especially preferably approximately 200 to 300% is obtained. The degree of expansion is calculated according to the formula [(density of the non-foamed sample*100/density of the foamed sample]−100=degree of expansion in %) according to PSA D45 1180/F with the aid of the method of Archimedes. The foaming takes place here at a temperature of 180° C. for 30 minutes.

As previously described, the expandable composition contains a curing agent for epoxy resins that is preferably activated by elevated temperature. The curing agent is advantageously selected from the group consisting of dicyandiamide, guanamine, guanidine, aminoguanidine and their derivatives. The use of dicyandiamide as curing agent is preferred in the framework of the invention. The amount of the curing agent is preferably more than approximately 0.01 wt %, in particular approximately 0.25 to 3 wt %, and especially preferably approximately 0.5 to 2 wt % relative to the total weight of the expandable composition. The amount of the curing agent is most preferably approximately 1 to 2 wt %.

The fibers to be included in the expandable composition of the invention, which can also be present in the form of fiber-like fillers, are preferably glass fibers. Furthermore, it may be advantageous to include aramid fibers in the composition of the invention. However, this does not lead in all cases to favorable effects, so that the composition of the invention contains no aramid fibers in one embodiment. The fiber content is approximately 5 to 30 wt %, preferably approximately 5 to 20 wt % and in particular approximately 10 to 15 wt % relative to the total weight of the expandable composition. Fibers or fiber-like fillers such as wollastonite raise the stability of hollow bodies during the curing phase (softening of the formulation and increase of the adhesion).

Other agents for increasing the impact strength can be added to the expandable compositions. They are, for example, organic ion-exchanged clay minerals in which at least a part of the cations were replaced by organic cations or at least a part of the anions by organic anions. Suitable clay minerals are in particular phyllosilicates such as kaolinite, montmorillonite, hectorite or illite or bentonite.

Preferred cation-exchanged clay minerals are known to the person skilled in the art under the designations of organoclay or nanoclay and are commercially obtainable, for example, under the group names Tixogel® or Nanofil® (Siidchemie), Cloisite® (Southern Clay Products) or Nanomer® (Nanocor Inc.) or Garmite® (Rockwood).

The expandable composition according to the invention contains as another constituent up to 10 wt % of a thixotropic agent such as, for example, hydrophobic or pyrogenic silica (Aerosil) or nanoclays that are preferably contained in an amount of approximately 1 to 5 wt %, in particular in an amount of approximately 1.5 to 3 wt % relative to the total weight of the expandable composition.

Furthermore, the expandable composition of the invention additionally contains at least one filler. The filler is preferably mica, talc, kaolin, wollastonite, feldspar, syenite, chlorite, bentonite, montmorillonite, calcium carbonate (precipitated or ground), dolomite, quartz, silica (pyrogenic or precipitated), cristobalite, calcium oxide, aluminum hydroxide, magnesium oxide, hollow ceramic spheres, hollow glass spheres, hollow organic spheres, glass spheres and/or colored pigments. Fillers comprise organically coated and also uncoated, commercially available forms known to a person skilled in the art. Other advantageous fillers are functionalized alumoxanes such as are described, e.g., in U.S. Pat. No. 6,322,890. Its content is incorporated here by reference.

The expandable composition of the invention contains one or more fillers with a proportion of approximately 10 to 40 wt %, preferably approximately 10 to 35 wt % and in particular approximately 12 to 24 wt % relative to the total weight of the expandable composition.

In an especially preferred embodiment a mixture of talc, calcium carbonate, hollow glass spheres and silica as thixotropic agent is used as a filler. The hollow glass spheres are preferably present in this mixture with a content of approximately 8 to 12 wt %, the calcium carbonate with a content of approximately 2 to 5 wt %, the talc with a content of approximately 1 to 4 wt % and the pyrogenic silica with a content of approximately 1 to 5 wt %.

In addition, the composition can contain other additives such as reactive diluents, stabilizers, in particular heat stabilizers and/or light stabilizers, plasticizers, solvents, blowing agents, dyes and pigments, anti-corrosion agents, surfactants, defoamers and adhesion promoters.

Suitable stabilizers are in particular optionally substituted phenols such as butylhydroxytoluene (BHT) or Wingstay® T (Elikem), sterically hindered amines or N-oxyl compounds such as TEMPO (Evonik). Suitable plasticizers are in particular phenol-alkylsulfonic acid esters or benzene sulfonic acid-N-butylamide that are commercially obtainable as Mesamoll® or Dellatol BBS from Bayer.

The amount of such additional additives should not exceed 10 wt % relative to the total expandable composition, and the amount of additional additives is preferably in the range of approximately 1 to 5 wt %.

Suitable catalysts in conjunction with the present invention are substituted ureas, for example, 3-(3-chloro-4-methylphenyl)-1,1-dimethylurea (chlortoluron), or phenyldimethylureas, in particular p-chlorophenyl-N,N-dimethylurea (monuron), 3-phenyl-1-1-dimethylurea (fenuron) or 3,4-dichlorophenyl-N,N-dimethylurea (diuron), N,N-dimethylurea, N-iso-butyl-N′,N′-dimethylurea, 1,1′-hexane-1-6-diyl)bis(3,3′-dimethylurea) and imidazoles, imidazole salts and amine complexes.

If the composition contains one or more catalysts, their content is in the range of approximately 0 to 1 wt %, especially preferably in the range of approximately 0.1 to 1 wt %, preferably and in particular in the range of approximately 0.2 to 0.7 wt % relative to the total weight of the expandable composition.

It is also preferred if the expandable composition contains wax in an amount of 0 to approximately 10 wt % in addition to the already cited contents. Preferred waxes in conjunction with the present invention are synthetic waxes, in particular polyethylene waxes. An especially suitable wax in conjunction with the present invention has a drop point (measured according to ASTM D-127) in the range of 110 to 130° C. and a molecular weight (Mn) in the range of approximately 1000 to 2000 g/mol, in particular approximately 1300 to 1800 g/mol. The wax is contained in the composition especially preferably with a content of approximately 1.5 to 6 wt %, in particular approximately 2 to 5 wt % and most preferably approximately 2 to 4 wt % relative to the total weight of the expandable composition.

Furthermore, it was found that the expandable composition should have good flow properties for its processing. This property can be described with the so-called Melt Flow Index (MFI). The Melt Flow Index cited here can be determined, for example, using the ISO 1133 standard. In the practice of the present invention the expandable composition preferably has a Melt Flow Index (MFI) in the range of 20 to 80 g/min (determined according to ISO 1133 at 110° C. and 2.16 kg), especially preferably an MFI of 30 to 60 g/min, and most preferably in the range of approximately 45 to 55 g/min (determined according to ISO 1133 at 110° C. and 2.16 kg).

Another characteristic value for the ability to process the compositions of the invention is their viscosity. At 100° C. it should probably be in the range of 1500 to 3500 Pas, especially preferably in the range of 2000 to 3000 Pas. If the viscosity is above these values the viscosity counteracts the expansion of the foam so that the foamable composition can fill out the hollow spaces only insufficiently. On the other hand, a viscosity that is too low can have the result that the foam becomes too liquid during the expansion and partially flows out of the hollow space.

The previously described expandable composition is furthermore preferably characterized in that it has a softening point in the range of approximately 55 to 110° C., especially preferably approximately 65 to 90° C. and most preferably approximately 70 to 85° C. Furthermore, the expandable composition should have a glass transition temperature in the range of approximately 30 to 55° C., and especially preferably in the range of approximately 40 to 50° C. These properties make it possible that the material is not sticky in spite of good flow properties at room temperature and can therefore be readily processed.

In another preferred embodiment the expandable composition is characterized in that it is completely cured by being heated to a temperature of approximately 140 to 200° C. for a period of about 30 to 60 min. “Completely cured” means in the context of the invention that the epoxy groups present in the composition react substantially completely at the designated temperature and in the indicated time period. During the curing the individual particles of granular material connect to each other so that a homogeneous foam structure is produced in which individual particles of granular material can no longer be recognized.

In an especially preferred embodiment the expandable composition in accordance with the invention comprises

| | | |
|---|---|---|
| 5 to 20 | wt % | Rubber-modified epoxy resin, |
| 40 to 60 | wt % | Solid epoxy resin, |
| 0.5 to 3 | wt % | Curing agent |
| 5 to 20 | wt % | Fibers, |
| 10 to 30 | wt % | Fillers, |
| 1 to 5 | wt % | Thixotropic agent, |
| 1.5 to 5 | wt % | Wax, |
| 0.1 to 1 | wt % | Catalyst, |
| 0.5 to 5 | wt % | Chemical and/or physical blowing agent. |

The expandable composition according to the invention quite especially preferably comprises

| | | |
|---|---|---|
| 5 to 10 | wt % | Rubber-modified epoxy resin, |
| 45 to 55 | wt % | Solid epoxy resin, |
| 0.5 to 3 | wt % | Curing agent |
| 10 to 15 | wt % | Fibers, |
| 10 to 30 | wt % | Fillers, |
| 1.5 to 3 | wt % | Thixotropic agent, |
| 1.5 to 5 | wt % | Wax, |
| 0.1 to 1 | wt % | Catalyst, |
| 1 to 3 | wt % | Chemical and/or physical blowing agent. |

Another aspect of the present invention relates to the use of a composition like the one previously described for stiffening hollow spaces that is characterized in that the composition expands inside the hollow space and is cured. Hollow spaces preferably denote in the scope of this invention spaces in which the expansion of an expanding material is limited at least in two spatial directions by the hollow space material. The composition, that is solid as a rule, can to this end first be filled into the hollow space, preferably at room temperature, and subsequently exposed to a temperature at which the composition softens, expands and is cured. In conjunction with the previously described use, it is furthermore preferred if the hollow body is a hollow body consisting of a metal, particularly of steel or aluminum, or of a composite material, especially of a glass fiber material or composite (GFC) or carbon fiber composite material or composite (CFC). The hollow bodies are furthermore preferably in the form of tubular hollow bodies (e.g. with rectangular cross section) or pipes, for example, for bicycle frames or sticks, in particular ski poles or walking sticks in the form of metallic 3-D attaching parts, preferably for a vehicle, in particular a bicycle carrier, or in the form of pieces of furniture or parts of them, preferably a chair or table. In an especially preferred embodiment the hollow space is the hollow space of a hollow body, preferably of a stick, roof support or of a vehicle component.

Another aspect of the present invention relates to a method for stiffening hollow spaces, comprising i) the filling of a hollow space with the preferably solid granular material of a composition as previously described, and ii) the heating of the filled hollow space to a temperature above the softening point of the composition and above the activation temperature of the blowing agent and of the catalyst, and for a time period until the composition has substantially become cured.

It is preferred in the framework of the presently described method if the filling of the hollow space takes place below the softening point of the composition. This can ensure that the material is not sticky and therefore during the filling into the hollow space no rather large hollow spaces filled with the composition are created. Therefore, in this embodiment of the method of the invention, processing of the composition of the invention in the framework of an injection molding method is excluded.

Furthermore, it is preferred in the framework of the previously described method if the filled hollow space in step ii) is heated to a temperature in the range of 140 to 200° C., especially preferably 160 to 180° C.

Finally, the present invention relates to hollow bodies that are filled with an expanded and cured composition obtainable from an expandable composition as previously described. Corresponding hollow bodies are advantageously obtainable by a method as previously described. Furthermore, it is preferred in the case of the filled hollow bodies if the composition expanded and cured in them has a density of ≦1 g/cm³, especially preferably ≦0.5 g/cm³. The invention is illustrated further in the following using examples that, however, are not intended to limit the scope of the present invention in any manner.

### Measuring the Degree of Expansion

The determination of the degree of expansion takes place according to PSA D45 1180/F. To this end foamed samples were produced in that the particular samples were exposed for 30 minutes to a temperature of 180° C. The required density measurements take place according to PSA D15 1163/B as follows. The appropriate samples are first weighed in an environment of air. Subsequently the samples, fastened on a needle, are immersed in water and the weight of the water container including the sample is determined. The density of the sample is found according to the formula: density (g/cm³)(M₁×δ_{H20})/M₂, wherein M₁ corresponds to the weight of the sample in air, M₂ to the weight of the sample in water and δ_{H2O} to the density of water at the measuring temperature. All density measurements were carried out at 25° C.

For the determination of the degree of expansion the densities of the non-foamed and foamed sample are determined. The expansion is then determined using the formula: degree of expansion (%)=(δ₁*100/δ₂)−100.

### EXAMPLE 1

A composition consisting of 40.6 wt % CTBN-modified epoxy resin, 21.3 wt % solid epoxy resin, 12.9 wt % glass fibers, 2.7 wt % of a thixotropic agent (pyrogenic silica), 15.6 wt % of a mixture of talc, calcium carbonate and hollow glass spheres, 3 wt % of a polyethylene wax, 1.4 wt % of a catalyst, 0.5 wt % of a co-catalyst and 2 wt % of a mixture of a physical and a chemical blowing agent was formulated as granular material. This composition has a Melt Flow Index of approximately 50 g/min.

A 16 mm aluminum tube and an 18 mm aluminum tube were filled with the granular material. A second tube with a diameter of 16 mm and one with a diameter of 18 mm were not filled with the granular material and were used as reference. The filled tubes were cured in a furnace at 180° C. for a time period of 0.5 h. After the expansion of the granular material composition in the tubes the weight of the tubes, their bending force and their bending deformation were determined. The results of this investigation are shown in the following table 1.

TABLE 1
Results of the 3-point bending test for aluminum tubes

| | 16 mm tube | | 18 mm tube | |
|---|---|---|---|---|
| | without | with | without | with |
| | granular | granular | granular | granular |
| | material | material | material | material |
| Weight [g] | 120 | 187 | 180 | 270 |
| Bending force [N] | 335 | 380 | 420 | 510 |
| Bending deformation [mm] | 72 | >130 | 54 | 123 |

It is found that the tubes filled with expanded granular material have clearly improved bending forces and bending deformations. It is also found, in a comparison of a 16 mm tube filled with granular material with a corresponding non-filled 18 mm tube, that given a comparable weight of both tubes (approximately 180 g) the bending force of both tubes is approximately comparable, while the bending deformation of the 16 mm tube filled with granular material greatly exceeds that of the 18 mm tube without granular material. Therefore, it is possible to produce tubes with improved bending deformation in spite of their having the same weight by introducing and expanding the granular material.

In the following the respective tubes were subjected to a compression test in that the compressive force required for the compression of a corresponding tube and the compliance (determined according to DIN EN 14509) were measured. The results of these investigations are shown in the following table 2,

TABLE 2
Results of the compression test

| | 16 mm tube | | 18 mm tube | |
|---|---|---|---|---|
| | without | with | without | with |
| | granular | granular | granular | granular |
| | material | material | material | material |
| Compressive force, 0.5 mm | 603 | 1738 | 502 | 1656 |
| [N] | | | | |
| Compliance 0.05-0.3 mm | 0.053 | 0.017 | 0.052 | 0.017 |
| [mm/kN per mm length] | | | | |

It turns out that in the elastic part of the measuring curve that corresponds to the E modulus of the material no significant rise in the stiffness was able to be achieved. However, the tubes filled with expanded granular material and with a diameter of 16 mm and 18 mm show a significantly improved compressive force and a clearly reduced compliance compared to corresponding tubes without granular material. Therefore, it is possible to significantly improve the mechanical properties of hollow bodies by filling in a granular material.

### EXAMPLE 2

In the following comparison the material compressive strength of the formulation in accordance with the invention was investigated with two commercially obtainable formulations. To this end a cylinder is directly produced from the granular material and another cylinder by an injection-molding method and they are compared. The sample preparation takes place by filling the granular material into a tubular cylinder that is coated with Teflon paper. The inside diameter of the tube is 20 mm (=diameter of the cylinder). The cylinder is shortened after the curing process and before the testing to 40 mm in height. The formulation of ref. 1 is a formulation based on liquid epoxy resin and polystyrene (Sika-Reinforcer® 911PB). Ref. 2 is also a commercial product based on solid epoxy resin (Sika-Reinforcer® 941). The composition of the invention corresponds to the composition described in example 1. The test was carried out according to EN 14509 (speed 10 mmmin).

TABLE 3
Results of the material pressure test

| | | Injection molded | Granular material |
|---|---|---|---|
| | Curing | cylinder | cylinder |
| Ref. 1 | 30 min. 180° C. | 13.0 MPa | 2.5 MPa |
| Ref. 2 | 30 min. 150° C. | 11.0 MPa | 3.0 MPa |
| Example 1 | 30 min. 150° C. | 13.0 MPa | 10.0 MPa |

The results show that a high compressive force can be set with the composition according to example 1 even in the production of a cylinder consisting of granular material whereas in the case of the commercially obtainable products a distinct drop in strength can be observed.

### EXAMPLE 3

A different composition consisting of 39.3 to 41.1 wt % CTBN-modified epoxy resin, 21.4 to 22.4 wt % solid epoxy resin, 12.7 to 13.3 wt % glass fibers, approximately 2.7 wt % of thixotropic agent (pyrogenic silica), approximately 14.5 wt % of a mixture of talc, calcium carbonate and hollow glass spheres, approximately 3 wt % of a polyethylene wax, 1.4 wt % of a catalyst, 0.5 wt % of a co-catalyst as well as different amounts of physical or chemical blowing agent were formulated as granular material. By way of comparison the composition Gref disclosed in EP 2 468 794 A1 was produced. The various compositions were foamed for 30 minutes at 180° C. and subsequently the expansion of the samples was determined in accordance with the method described above. In addition, the viscosity of the non-foamed samples was determined at 100° C. using an AX 2000ex rheometer with plate-plate geometry (TA Instruments) using the following parameters: frequency sweep=0.01-10 Hz, oscillation=3% strain; 1 rad/sec. Finally, the compressive strength of all samples was determined using a plate foamed from 3 mm to 6 mm, wherein the compressive strength was measured in the direction of the expansion. The foaming conditions were 180° C. for 30 minutes; the compressive strength is indicated in MPa. The results of these measurements and the exact compositions are reproduced in the following table 4.

TABLE 4

| | Gref | Ex. 1 | Ex. 2 | Ex. 3 | Ex. 4 | Ex. 5 |
|---|---|---|---|---|---|---|
| Epoxy resin | 21.78 | 21.96 | 21.72 | 21.40 | 22.35 | 22.07 |
| CTBN- | 40.00 | 40.36 | 39.95 | 39.34 | 41.09 | 40.57 |
| modified | | | | | | |
| epoxy resin | | | | | | |
| Fibers | 14.23 | 13.02 | 12.88 | 12.69 | 13.25 | 13.09 |
| Thixotropic | 2.72 | 2.74 | 2.72 | 2.67 | 2.79 | 2.76 |
| agent | | | | | | |
| Fillers | 11.67 | 14.48 | 14.35 | 14.12 | 14.75 | 14.57 |
| Wax | 6.80 | 3.03 | 3.00 | 2.95 | 3.08 | 3.04 |
| Curing agent | 1.36 | 1.42 | 1.42 | 1.39 | 1.45 | 1.43 |
| Catalyst | 0.42 | 0.46 | 0.46 | 0.45 | 0.47 | 0.47 |
| Chem. blowing | 0.52 | 0.00 | 0.00 | 0.00 | 0.75 | 2.00 |
| agent | | | | | | |
| Phys. blowing | 0.5 | 2.52 | 3.50 | 5.00 | 0.00 | 0.00 |
| agent | | | | | | |
| Total | 100 | 100 | 100 | 100 | 100 | 100 |
| Viscosity [Pas] | 4000 | 2000 | 2000 | 3000 | 2000 | 2000 |
| Expansion [%] | 180 | 209 | 259 | 416 | 240 | 397 |
| Compressive | 8.8 | 7.9 | 7.2 | 5.5 | 4.9 | 1.8 |
| strength [MPa] | | | | | | |

In the measurements higher compressive strengths were present for the samples foamed with physical blowing agents with comparable expansion than in the samples foamed only with chemical blowing agents.

1. An expandable composition in the form of a granular material, comprising

| | | |
|---|---|---|
| 30-75 | wt % | epoxy resin, |
| up to 5 | wt % | blowing agent, |
| up to 5 | wt % | curing agent, |
| 5-30 | wt % | fibers, |
| 10-40 | wt % | fillers, |
| up to 10% | wt % | thixotropic agent, |
| 0-10 | wt % | wax, and |
| 0-1 | wt % | catalyst, |

wherein the information in wt % refers in each instance to the total weight of the expandable composition.

2. The expandable composition according to claim 1, wherein the epoxy resin is present in the form of a mixture of a solid epoxy resin and a rubber-modified epoxy resin with a ratio of 6:1 to 4:1.

3. The expandable composition according to claim 1, wherein the fibers are present in the form of glass fibers.

4. The expandable composition according to claim 1, wherein the wax is present in the form of a synthetic wax in the form of a polyethylene wax.

5. The expandable composition according to claim 1, wherein the blowing agent is present in the form of a mixture of a physical and a chemical blowing agent and that the composition has a degree of expansion after expansion for 30 minutes at 180° C. of 150% to 500%.

6. The expandable composition according to claim 1, wherein it has a Melt Flow Index (MFI) in the range of 20 to 80 g/min (determined according to ISO 1133 at 110° C. and 2.16 kg) in the range of 30 to 60 g/min.

7. The expandable composition according to claim 1, wherein it has a softening point in the range of approximately 65° C. to approximately 90° C. and a glass transition temperature in the range of approximately 30° C. to approximately 55° C.

8. The expandable composition according to claim 1, wherein the composition is completely cured by being heated to a temperature of 140° C. to 200° C. for a time of 30 to 60 min.

9. A composition according to claim 1 for stiffening hollow spaces wherein the composition is expanded and cured inside the hollow space.

10. A composition according to claim 9, wherein the hollow space is the hollow space of a hollow body of at least one of aluminum, CFC and/or GFC.

11. A method for stiffening hollow spaces, comprising
i) the filling of a hollow space with the granular material according to claim 1, and
ii) the heating of the of the filled hollow space to a temperature above the softening point of the composition and above the activation temperature of the blowing agent and of the catalyst, and for a time period until the composition has substantially cured.

12. The method according to claim 11, wherein the filling of the hollow space takes place below the softening temperature of the composition.

13. The method according to claim 11 the filled hollow space in step ii) is heated to a temperature in the range of 140° C. and 200° C.

14. A hollow body filled with an expanded and cured composition obtainable from a composition according to claim 1.

15. The hollow body according to claim 14, wherein the expanded and cured composition has a density ≦0.5 g/cm³.
